(19) United States
(12) Patent Application Publication
(10) Pub. No.: US 2022/0309442 A1
(43) Pub. Date: Sep. 29, 2022

(54) SERVER AND METHOD

(71) Applicant: TOSHIBA TEC KABUSHIKI KAISHA, Tokyo (JP)

(72) Inventor: Hirokazu Matsuno, Numazu Shizuoka (JP)

(21) Appl. No.: 17/541,305

(22) Filed: Dec. 3, 2021

(30) Foreign Application Priority Data
Mar. 26, 2021 (JP) 2021-052797

(51) Int. Cl. G06Q 10/08; B62B 5/00; B65G 1/137; G06Q 30/02; B65G 1/04; G06Q 10/06

(52) U.S. Cl. CPC G06Q 10/087; B62B 5/0096; B65G 1/1373; G06Q 30/0202; B65G 1/0492; G06Q 10/063112; B65G 2203/0216; B65G 2209/04

(57) ABSTRACT

According to one embodiment, a server includes a product position storage unit configured to store a storage position of a product in association with each product, a cart position storage unit configured to store a position of a cart, a cart determining unit configured to determine a cart positioned closest to a product-to-pick ordered from an ordering party, based on the storage position of the product and the position of the cart, and a product information transmitting unit configured to transmit information on the product-to-pick to a cart terminal attached to the determined cart for display thereof.

### CROSS-REFERENCE TO RELATED APPLICATION

This application is based upon and claims the benefit of priority from Japanese Patent Application No. 2021-052797, filed on Mar. 26, 2021, the entire contents of which are incorporated herein by reference.

### FIELD

Embodiments described herein relate generally to a server and a method.

### BACKGROUND

In the related art, when picking ordered products or the like in a distribution warehouse or the like that stores and ships products, for example, picking carts are used. The worker patrols the distribution warehouse and picks the products while checking the order information. At that time, the picking time is shortened by shortening the route from the start to the end of the order and the like.

However, in a distribution warehouse in which a plurality of picking carts are in operation, further reduction in picking time is required.

### DESCRIPTION OF THE DRAWINGS

FIG. 1 is a diagram illustrating the inside of a distribution warehouse according to an embodiment;

FIG. 2 is a diagram illustrating a system;

FIG. 3 is a diagram illustrating a cart;

FIG. 4 is a block diagram illustrating a hardware configuration of a server;

FIG. 5 is a memory map illustrating a configuration of an area information unit;

FIG. 6 is a memory map illustrating a configuration of a worker information unit;

FIG. 7 is a memory map illustrating a configuration of a cart information unit;

FIG. 8 is a memory map illustrating a configuration of an order product unit;

FIG. 9 is a block diagram illustrating a hardware configuration of a cart terminal;

FIG. 10 is a memory map illustrating a configuration of the order product unit;

FIG. 11 is a functional block diagram illustrating a functional configuration of a server;

FIG. 12 is a flowchart illustrating a flow of control process of a server; and

FIG. 13 is a flowchart illustrating a flow of control process of a cart terminal.

### DETAILED DESCRIPTION

An aspect to be solved by an exemplary embodiment is to provide a server and a method capable of reducing the time required for picking operation.

In general, according to one embodiment, a server includes a product position storage unit configured to store a storage position of a product in association with each product, a cart position storage unit configured to store a position of a cart, a cart determining unit configured to determine a cart positioned closest to a product-to-pick ordered from an ordering party, based on the storage position of the product and the position of the cart, and a product information transmitting unit configured to transmit information on the product-to-pick to a cart terminal attached to the determined cart for display thereof.

Hereinafter, embodiments will be described with reference to the drawings. In an embodiment, for example, a mass merchandiser such as a supermarket and the like, a specialty shop, a shop such as a convenience store, and the like will be described as an example of an ordering party. It should be noted that an exemplary embodiment is not limited to the embodiments described below.

The distribution warehouse of an embodiment (hereinafter referred to as “warehouse”) stores a large amount of products to be delivered to shops, for example. If an order for a product is received from a shop that wants to have the product delivered, the worker picks the ordered product, and places it in a picking cart (hereinafter referred to as “cart”) while moving the cart in the warehouse. If the picked products are placed in the cart, the products are placed in the pallets prepared for each of the shops that placed the orders. The products picked in this way are delivered to the shop of the ordering party.

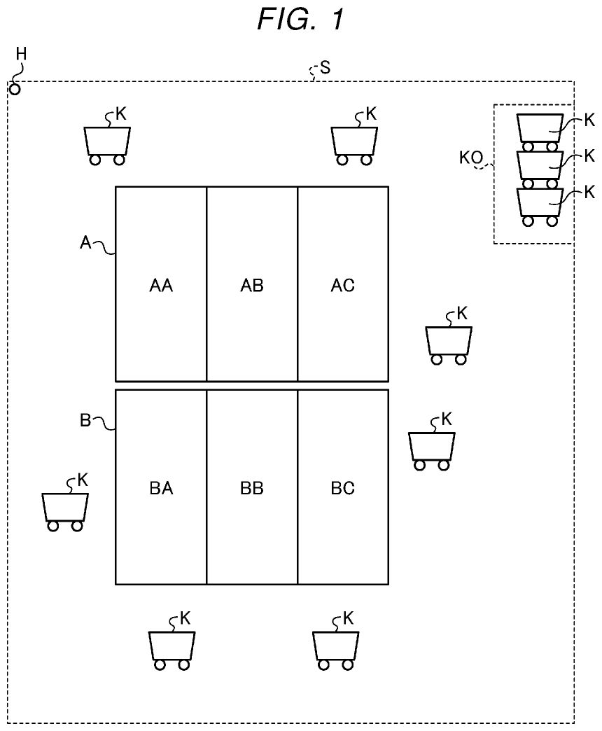

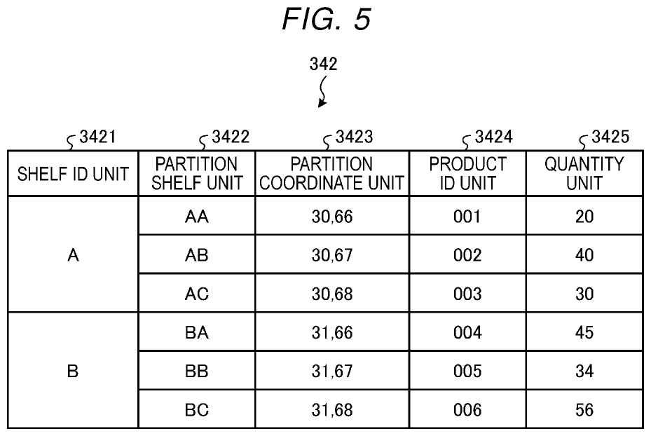

FIG. 1 is a diagram illustrating the inside of a warehouse S according to an embodiment. The warehouse S is provided with a shelf A and a shelf B for storing products. The shelf A is partitioned into three areas: a partition shelf AA, a partition shelf AB, and a partition shelf AC. The shelf B is partitioned into three areas: a partition shelf BA, a partition shelf BB, and a partition shelf BC. The partition shelf AA stores 20 products (see FIG. 5, the same applies hereinafter) having a product identity (ID) (a code for specifying the product and the manufacturer) of “001”, for example. The partition shelf AB stores 40 products having a product ID of “002”, for example. The partition shelf AC stores 30 products having a product ID of “003”, for example. The partition shelf BA stores 45 products having a product ID of “004”, for example. The partition shelf BB stores 34 products having a product ID of “005”, for example. The partition shelf BC stores 56 products having a product ID of “006”, for example.

In addition, in the warehouse S, a plurality of carts K are moved while picking products. Each cart K is moved by a separate worker. The cart K is gathered and placed in a cart storage KO, and the worker takes out the cart K from the cart storage KO and picks the ordered products from each shelf.

While the details will be described below, the current position (coordinate position when the home position is (x coordinate=0, y coordinate=0)) of the cart K with respect to home position H is managed. Further, storage positions of the products stored on the shelves A and B are also managed as the coordinates with respect to the home position H. As described above, by managing the position of the cart K and the storage position of each product, the distance between the cart K and the product can be calculated. That is, based on the coordinate position where the product is positioned and the coordinate of the cart K, the distance between the corresponding product and the cart K can be calculated.

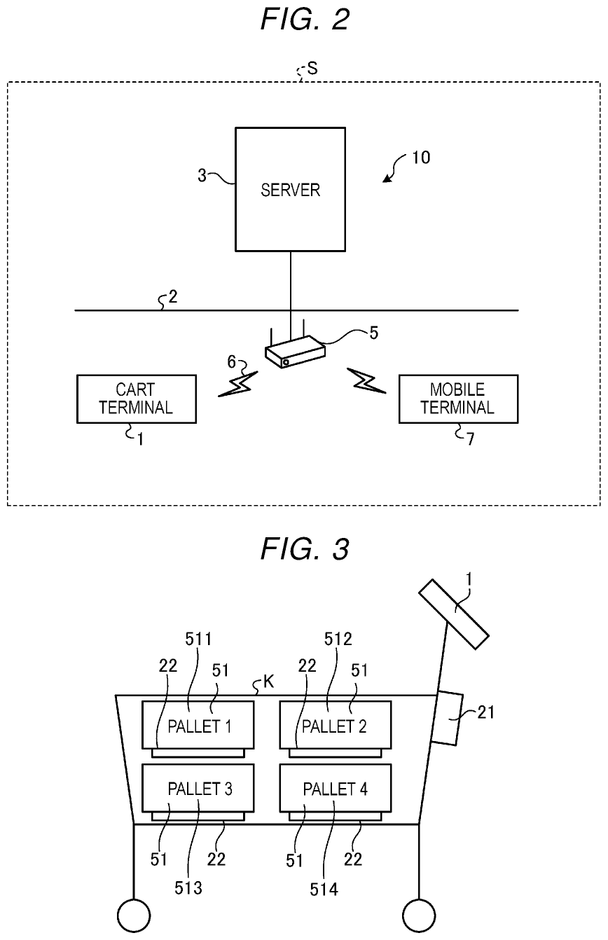

Next, a system provided in the warehouse S will be described. FIG. 2 is a diagram illustrating a system according to an embodiment. As illustrated in FIG. 2, a system 10 includes a cart terminal 1, a server 3, a wireless repeater 5, and a mobile terminal 7. The server 3 and the wireless repeater 5 are connected to each other via a communication line 2 (e.g., a Local Area Network (LAN)). The wireless repeater 5 and the cart terminal 1 are connected via a wireless communication line 6 (e.g., a wireless LAN). The wireless repeater 5 and the mobile terminal 7 are connected via the wireless communication line 6. That is, the server 3 is connected to the cart terminal 1 and the mobile terminal 7 via the wireless repeater 5.

The server 3 manages types and numbers of the products stored in the warehouse S and the coordinates of the storage position of each product. The server 3 manages the coordinates of the position of the cart terminal 1 positioned in the warehouse S. The server 3 manages the coordinates of the position of the mobile terminal 7 positioned in the warehouse S. Further, the server 3 manages a skill level of each worker in the warehouse S for the products of each shop and the like. Specifically, the server 3 manages a picking speed (that is, the skill level) of each worker based on the amount of experience of the corresponding worker in picking the product for each shop. That is, a worker who has a large amount of experience in picking various products in a certain shop is managed as having a high skill level, because the speed and accuracy of picking the products in the corresponding shop are superior to those of other workers. As described above, the skill level for each shop is managed for each worker.

The server 3 determines (selects) one cart K having the shortest distance to move to pick all the ordered products based on the types of the ordered products. The server 3 transmits order information for displaying information on the ordered product (product code for specifying the product, product name, number of orders, and the like) and route information indicating a movement route to the determined cart K. Further, the server 3 transmits, to the mobile terminal 7, instruction information for instructing the worker carrying the mobile terminal 7 to perform the picking operation.

The cart terminal 1 is attached to each cart K. Therefore, the position information of the cart terminal 1 identified by the server 3 is also the position information of the cart K to which the cart terminal 1 is attached. The cart terminal 1 displays the order information and the route information received from the server 3. Further, the cart terminal 1 transmits the position information (coordinates) of the cart terminal 1 to the server 3 at predetermined time intervals (e.g., once per minute).

The mobile terminal 7 is a portable terminal device such as a mobile phone, a smartphone, a Personal Data Assistant (PDA), a tablet terminal, and the like. The mobile terminal 7 is carried by each worker. Therefore, the position information of the mobile terminal 7 identified by the server 3 is also the position information of the worker who carries the mobile terminal 7. The mobile terminal 7 notifies the information received from the server 3. Further, the mobile terminal 7 transmits the position information (coordinates) of the mobile terminal 7 to the server 3 at predetermined time intervals (e.g., once per minute).

Next, the cart K will be described. FIG. 3 is a diagram illustrating the cart K. As illustrated in FIG. 3, the cart K can be moved by rotating the casters and the picked products are sorted according to shops and stored therein. The cart K includes a plurality of pallets 51. Each pallet 51 is, for example, a box-shaped case having an opening at the top, and is where the products stored in the other pallets 51 are not mixed. In an embodiment, four pallets 51 (pallet 511, pallet 512, pallet 513, and pallet 514) are provided. That is, in the cart K according to an embodiment, products of up to four shops can be sorted and stored. In case of multiple orders, a plurality of pallets 51 may be used for one shop.

A weighing unit 22 (scale) is provided at the bottom of each pallet 51. The weighing unit 22 weighs the product placed in the pallet 51. The weighing unit 22 is provided for each pallet 51, and the cart K (cart terminal 1) can identify which pallet 51 the product is placed in.

In addition, a scanner 21 is attached to the cart K. The scanner 21 reads a symbol such as a barcode and the like attached to the product, optically or by capturing images.

Further, the cart terminal 1 is attached to the cart K. The cart terminal 1 is attached to a position (e.g., a handle of the cart K) that is easy for the worker to operate.

The cart terminal 1 displays the order information and the route information received from the server 3. The worker moves the cart K according to the displayed route information, and picks the ordered product while looking at the displayed order information.

The worker reads the symbol attached to the picked product with the scanner 21. The cart terminal 1 compares the product code acquired from the symbol with the product code included in the order information, and stores the product information of the product if the information matches. Further, the weighing unit 22 weighs the product placed in the pallet 51 and determines whether or not the product read by the scanner 21 is placed therein.

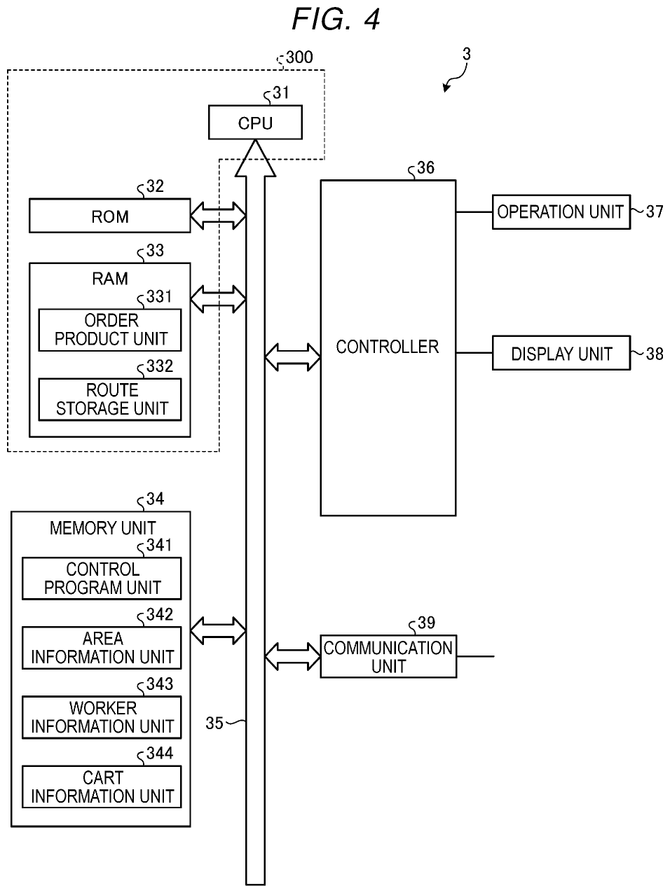

The hardware of the server 3 will now be described. FIG. 4 is a block diagram illustrating a hardware configuration of the server 3. As illustrated in FIG. 4, the server 3 includes a Central Processing Unit 31 (CPU), a Read Only Memory 32 (ROM), a Random Access Memory 33 (RAM), a memory unit 34, and the like. The CPU 31 is a control body. The ROM 32 stores various programs. The RAM 33 loads programs and various data. The memory unit 34 stores various programs. The CPU 31, the ROM 32, the RAM 33, and the memory unit 34 are connected to each other via a bus 35. The CPU 31, ROM 32, and RAM 33A configure a control unit 300. That is, the control unit 300 executes a control process of the server 3, which will be described below, by operating the CPU 31 according to the control program stored in the ROM 32 or the memory unit 34 and loaded into the RAM 33.

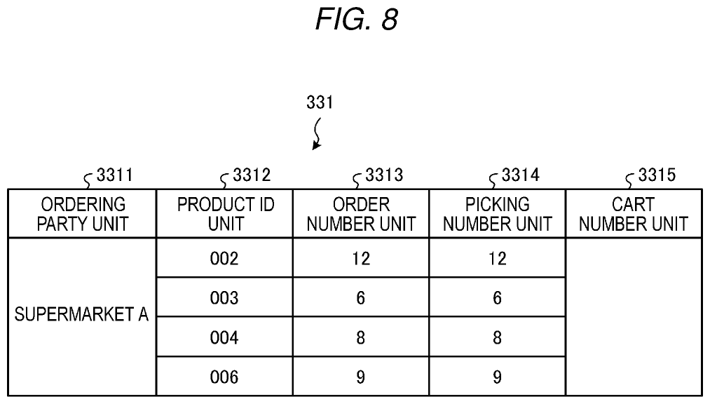

The RAM 33 includes an order product unit 331 and a route storage unit 332. The order product unit 331 stores order information (product code, product name, number of orders, and the like) of the ordered product. The order product unit 331 will be described below with reference to FIG. 8. The route storage unit 332 stores the movement route of the cart K for picking the ordered product. It will be described below as to how the route is described.

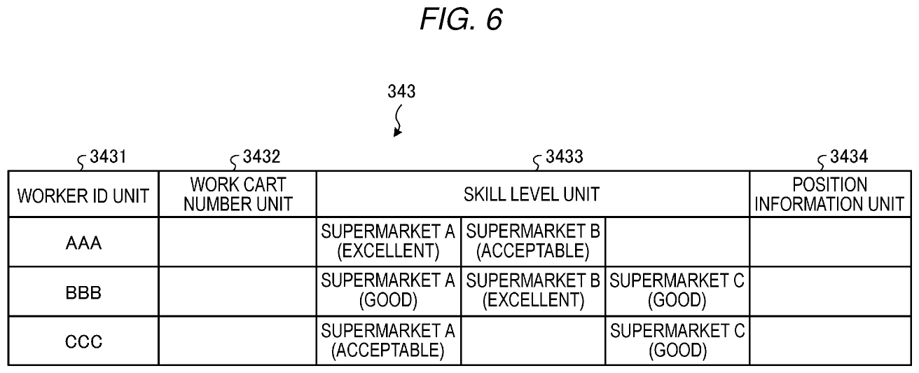

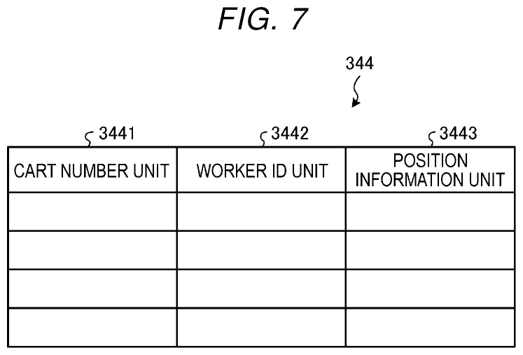

The memory unit 34 includes a non-volatile memory such as an Hard Disc Drive (HDD), a flash memory, and the like that latches stored information even if the power is turned off, and includes a control program unit 341 configured to store a control program for controlling the server 3, an area information unit 342 (product position storage unit), a worker information unit 343 (skill level storage unit), and a cart information unit 344 (cart position storage unit). The area information unit 342 will be described below with reference to FIG. 5. The worker information unit 343 will be described below with reference to FIG. 6. The worker information unit 343 will be described below with reference to FIG. 7.

Further, the control unit 300 is connected to an operation unit 37 and a display unit 38 via the bus 35 and a controller 36. The controller 36 controls the operation unit 37 and the display unit 38 in response to an instruction from the control unit 300. However, for convenience of explanation, it will be described that the control unit 300 performs the control performed by the controller 36. The operation unit 37 is a keyboard or a touch panel, for example, and is operated by an operator of the server 3. The display unit 38 is a liquid crystal display, for example, and displays information for the operator of the server 3.

Further, the control unit 300 is connected to a communication unit 39 via the bus 35. The communication unit 39 connects the cart terminal 1 and the mobile terminal 7 via the communication line 2 and the wireless communication line 6. Further, the communication unit 39 is connected to an external device (not illustrated) in order to receive an order for product.

The area information unit 342 will now be described. The area information unit 342 stores the types and numbers of products stored for each shelf. Further, the area information unit 342 stores the storage position (coordinates) in which the product is stored, in association with the product. FIG. 5 is a memory map illustrating a configuration of the area information unit 342. As illustrated in FIG. 5, the area information unit 342 includes a shelf ID unit 3421, a partition shelf unit 3422, a partition coordinate unit 3423, a product ID unit 3424, and a quantity unit 3425.

The shelf ID unit 3421 stores an ID that specifies the shelf. In an embodiment, the shelf ID unit 3421 stores a shelf ID that specifies the shelf A and a shelf ID that specifies the shelf B. Each shelf is partitioned into a plurality of shelves, and the partition shelf unit 3422 stores information for specifying each partition shelf. In an embodiment, the shelf A is partitioned into a partition shelf AA, a partition shelf AB, and a partition shelf AC. The shelf B is partitioned into a partition shelf BA, a partition shelf BB, and a partition shelf BC. The partition coordinate unit 3423 stores information indicating the coordinates of each partition shelf. For example, the partition shelf AA is positioned at a position of x-coordinate=30 and y-coordinate=66.

The product ID unit 3424 stores a product ID including a product code that specifies the product stored in each partition shelf and a manufacturer code that specifies a manufacturer of the corresponding product. For example, the product ID of the product stored in the partition shelf AA is “001”. The quantity unit 3425 stores the number of products stored in each partition shelf.

The worker information unit 343 will now be described. The worker information unit 343 stores various information of a worker. The worker information unit 343 stores a skill level of picking operation of a product for each shop for each worker. The worker information unit 343 stores the current position information (coordinates) of each worker. The worker information unit 343 stores information on whether or not each worker is in the picking operation using the cart K.

FIG. 6 is a memory map illustrating a configuration of the worker information unit 343. As illustrated in FIG. 6, the worker information unit 343 includes a worker ID unit 3431, a work cart number unit 3432, a skill level unit 3433, and a position information unit 3434. The worker ID unit 3431 stores an ID of the worker which specifies the worker. The work cart number unit 3432 stores a cart number that specifies whether or not the worker is performing the picking operation using the cart K, and the cart K that is being used. When stored in the work cart number unit 3432, the cart number indicates that the worker is performing the picking operation using the cart K specified by the cart number. When not stored in the work cart number unit 3432, the cart number indicates that the worker is not performing the picking operation.

The skill level unit 3433 stores the skill levels of the corresponding worker in picking the products of each shop. For example, a worker with a worker ID “AAA” is stored as the skill level of “EXCELLENT” for Supermarket A and stored as the skill level of “ACCEPTABLE” for Supermarket B. This indicates that the worker with the worker ID “AAA” has abundant experience in picking the products of Supermarket A, and that the worker with the worker ID “AAA” can perform picking of the products of Supermarket A in a short time. That is, the worker with the worker ID “AAA” is familiar with the storage locations of the products of Supermarket A on the shelves from experience, and can quickly find and pick the products when picking the products of Supermarket A. In addition, the worker who has the skill level “EXCELLENT” for picking the products of the shop makes few picking mistakes.

Meanwhile, a worker with the worker ID “BBB” is stored as the skill level of “GOOD” for Supermarket A, stored as the skill level of “EXCELLENT” for Supermarket B, and stored as the skill level of “GOOD” for Supermarket C. This indicates that the worker with the worker ID “BBB” has abundant experience in picking the products of Supermarket B and can pick the products of Supermarket B in a short time. However, the skill level for Supermarket A is “GOOD”. This indicates that the worker has some experience, but not as abundant as that of the worker with the worker ID “AAA” when it comes to the experience of picking the products of Supermarket A, such that this worker cannot pick as quickly as the worker with the worker ID “AAA”.

Further, a worker with the worker ID “CCC” is stored as the skill level of “ACCEPTABLE” for Supermarket A and stored as the skill level of “GOOD” for Supermarket C. This indicates that the worker with the worker ID “CCC” has less experience in picking products of Supermarket A than the worker with the worker ID “BBB”, and cannot pick as quickly as the worker with the worker ID “BBB”. That is, this indicates that, for picking of the products of Supermarket A, the worker with the worker ID “AAA” completes in the shortest time, the worker with the worker ID “BBB” in the second shortest time, and the worker with the worker ID “CCC” completes in the longest time. In addition, workers with a lower skill level are more likely to make mistakes during picking operation.

The position information unit 3434 stores, for each worker, the position information (coordinate position) of a current position of each worker. That is, the position information unit 3434 stores, for each worker (that is, for each mobile terminal 7), the current position information (coordinates) of the mobile terminal 7 carried by each worker.

The cart information unit 344 will now be described. The cart information unit 344 stores information on each cart K. FIG. 7 is a memory map illustrating a configuration of the cart information unit 344. As illustrated in FIG. 7, the cart information unit 344 includes a cart number unit 3441, a worker ID unit 3442, and a position information unit 3443. The cart number unit 3441 stores a number assigned to each cart K to specify the cart K. The worker ID unit 3442 stores the worker ID that specifies the worker who is using the cart K. The cart K having the worker ID stored in the worker ID unit 3442 indicates that the cart K is being used by the worker. The cart K not having the worker ID stored in the worker ID unit 3442 indicates that the cart K is not in use.

The position information unit 3443 stores the current position information (coordinates) of the corresponding cart K for each cart K. That is, the position information unit 3443 stores, for each cart K (that is, for each cart terminal 1), the current position information of the cart terminal 1 attached to the cart K.

The order product unit 331 will now be described. The order product unit 331 stores order information on the ordered product. FIG. 8 is a memory map illustrating a configuration of the order product unit 331. It should be noted that although FIG. 8 illustrates only the order information on the order received from the shop Supermarket A, the order product unit 331 stores, for each shop, the order information of all the shops where the order is received.

As illustrated in FIG. 8, the order product unit 331 includes an ordering party unit 3311, a product ID unit 3312, an order number unit 3313, a picking number unit 3314, and a cart number unit 3315.

The ordering party unit 3311 stores the ordering party of the ordered product. The product ID unit 3312 stores a product ID that specifies the ordered product. The order number unit 3313 stores the number of orders of the ordered product. The picking numbering unit 3314 stores the number of pickings completed among the ordered products. The cart number unit 3315 stores a cart number of the cart K used for picking the ordered product.

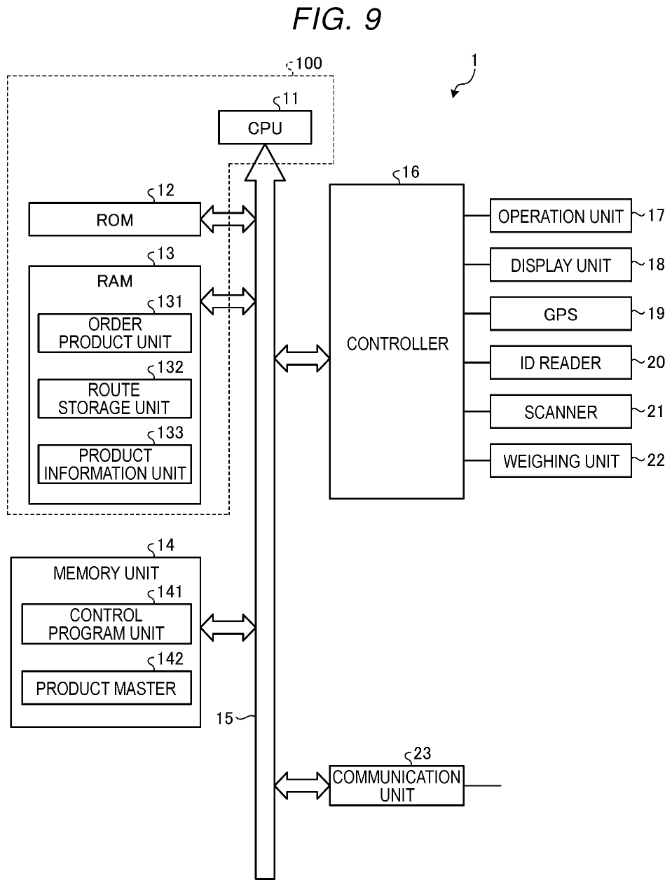

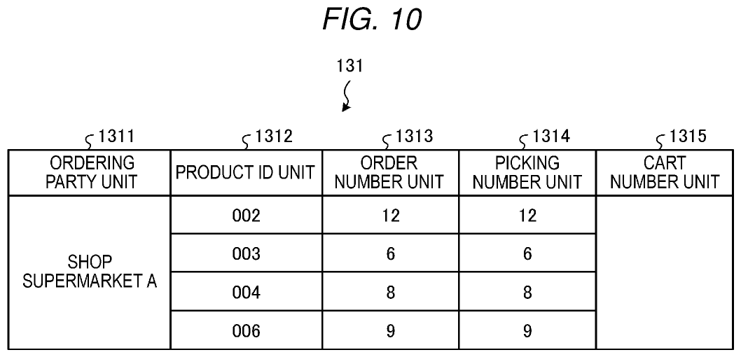

The hardware of the cart terminal 1 will now be described. FIG. 9 is a block diagram illustrating a hardware configuration of the cart terminal 1. As illustrated in FIG. 9, the cart terminal 1 includes a CPU 11, a ROM 12, a RAM 13, a memory unit 14, and the like. The CPU 11 is a control body. The ROM 12 stores various programs. The RAM 13 loads programs and various data. The memory unit 14 stores various programs. The CPU 11, the ROM 12, the RAM 13, and the memory unit 14 are connected to each other via a bus 15. The CPU 11, the ROM 12, and the RAM 13 configure the control unit 100. That is, the control unit 100 executes the control process of the cart terminal 1, which will be described below, by operating the CPU 11 according to the control program stored in the ROM 12 or the memory unit 14 and loaded into the RAM 13.

The RAM 13 includes an order product unit 131, a route storage unit 132, and a product information unit 133. The order product unit 131 stores the order information (product code, product name, number of orders, and the like) on the ordered product received from the server 3. The configuration of the order product unit 131 is the same as that of the order product unit 331. The route storage unit 132 stores a movement route of the cart K for picking the ordered product, which is received from the server 3. The route information stored in the route storage unit 132 is the same information as the route information stored in the route storage unit 332.

The memory unit 14 includes a non-volatile memory such as an HDD or a flash memory that latches stored information even if the power is turned off, and includes a control program unit 141 configured to store a control program that controls the cart terminal 1, and a product master 142. The product master 142 stores, for each product, the product information (product ID, product name, and the like).

Further, the control unit 100 is connected to an operation unit 17, a display unit 18, a Global Positioning System (GPS) 19, an ID reader 20, the scanner 21, and the weighing unit 22 via the bus 15 and the controller 16. The controller 16 receives an instruction from the control unit 100 and controls the operation unit 17, the display unit 18, the GPS 19, the ID reader 20, the scanner 21, and the weighing unit 22. However, for convenience of explanation, it will be described that the control unit 100 performs the control performed by the controller 16. For example, the operation unit 17 is a keyboard or a touch panel, and is operated by a worker who moves the cart terminal 1. For example, the display unit 18 is a liquid crystal display, and displays information to the worker. The GPS 19 identifies the current position of the cart terminal 1 (that is, the cart K). The ID reader 20 reads the worker ID written on a name tag or the like carried by the worker. The scanner 21 reads the product ID attached to the product. The weighing unit 22 weighs the products placed in the cart K (to be exact, the pallet 51).

Further, the control unit 100 is connected to a communication unit 23 via the bus 15. The communication unit 23 connects the server 3 and the mobile terminal 7 via the communication line 2 and the wireless communication line 6.

The order product unit 131 will now be described. The order product unit 131 has the same configuration as that of the order product unit 331, and includes an ordering party unit 1311, a product ID unit 1312, an order number unit 1313, a picking number unit 1314, and a cart number unit 1315. The ordering party unit 1311, the product ID unit 1312, the order number unit 1313, the picking number unit 1314, and the cart number unit 1315 have the same functions as those of the ordering party unit 3311, the product ID unit 3312, the order number unit 3313, the picking number unit 3314, and the cart number unit 3315 described above. The order product unit 331 stores information on all the shops that placed orders, but the order product unit 131 stores only the information on the shop for which the product is currently being picked or the product is going to be picked.

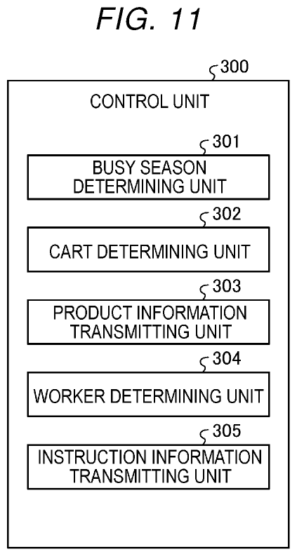

The functional configuration of the server 3 will now be described. FIG. 11 is a functional block diagram illustrating a functional configuration of the server 3. As illustrated in FIG. 11, according to the control program stored in the control program unit 341 of the ROM 32 and the memory unit 34, the control unit 300 serves as a busy season determining unit 301, a cart determining unit 302, a product information transmitting unit 303, a worker determining unit 304, and an instruction information transmitting unit 305.

The busy season determining unit 301 determines whether it is currently a busy season or else (that is, if it is a low season). The busy season determining unit 301 may determine that it is the busy season when it is currently during a predetermined period (e.g., a specific time zone of the day or a specific period of the year). In this case, when it is currently not during the predetermined period, the busy season determining unit 301 determines that it is not the busy season. In addition, the busy season determining unit 301 may determine that it is the busy season when it is currently designated as the busy season by the operation of the server 3. In this case, when it is currently not designated as the busy season, the busy season determining unit 301 determines that it is not the busy season.

The cart determining unit 302 determines a cart K positioned closest to a product-to-pick which is ordered from the ordering party, based on the storage position of the product and the position of the cart K (that is, the cart terminal 1). Specifically, the cart determining unit 302 calculates a distance (a movement distance of the cart K) between the product-to-pick and each cart K, and determines (selects) the cart K at a position of the shortest distance for picking all the products, based on the position information of the products stored in the partition shelf unit 3422 and the current position information of each cart K stored in the position information unit 3443. At this time, since the routes through which the carts K can pass in the warehouse S are determined in advance, the carts K are moved along these routes, and the movement distance between the product-to-pick and each cart K is calculated and the cart K of the shortest movement distance is determined.

Further, the cart determining unit 302 determines the cart K when the busy season determining unit 301 determines that it is the busy season. The cart determining unit 302 does not determine the cart K when the busy season determining unit 301 determines that it is not the busy season.

The product information transmitting unit 303 transmits the order information on the product-to-pick to the cart terminal 1 attached to the determined cart K for display thereof. Specifically, the product information transmitting unit 303 transmits the order information including the product ID and the number of orders of the product-to-pick, which is stored in the order product unit 331, to the cart terminal 1 attached to the determined cart K for display on the cart terminal 1.

The product information transmitting unit 303 according to an embodiment includes route information indicating a movement route of the cart K. For example, the movement route of the cart K is determined by a known route determining unit in the order of picking from the product positioned closest to the cart K to the product positioned farther therefrom, based on the position information of a position where the product is stored, which is stored in the partition shelf unit 3422, and the position information of the current position of each cart K, which is stored in the position information unit 3443.

The worker determining unit 304 determines the workers in a descending order of skill level concerning the ordering party, based on the information of the ordering party that placed the order. Specifically, the worker determining unit 304 determines a worker with the highest skill level for the corresponding shop, based on the skill level for each shop which is stored in the skill level unit 3433 for each worker based on the information on the ordering party (shop) that placed the order. In addition, if the cart number is stored in the work cart number unit 3432 relating to the worker who is being determined, since the corresponding worker is working with the cart K in which the cart number is stored, the worker with the next highest skill level is determined. In addition, if the worker being determined is short on time to be engaged in the remaining work for reasons such as a part-time job or the like, for example (e.g., when the worker is leaving the office in 30 minutes), the worker with next highest skill level is determined.

Further, the worker determining unit 304 determines the worker if the busy season determining unit 301 determines that it is not the busy season. The worker determining unit 304 does not determine the worker if the busy season determining unit 301 determines that it is the busy season.

The instruction information transmitting unit 305 transmits picking instruction information to the mobile terminal 7 carried by the determined worker. Specifically, the instruction information transmitting unit 305 transmits the instruction information indicating the instruction to perform the picking operation using the cart K, to the mobile terminal 7 carried by the determined worker.

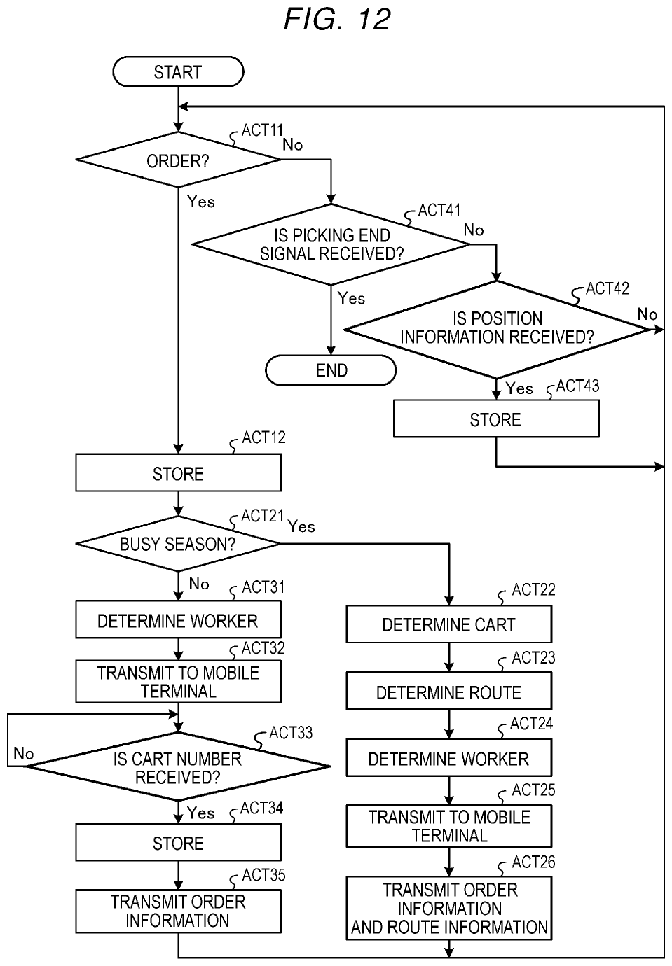

The control of the server 3 will now be described. FIG. 12 is a flowchart illustrating a flow of control process of the server 3. As illustrated in FIG. 12, the control unit 300 of the server 3 determines whether or not there is an order for product received from the shop (ACT 11). If it is determined that the order for product is received (YES in ACT 11), the control unit 300 stores the order information in the order product unit 331 (ACT 12).

Next, the busy season determining unit 301 determines whether or not it is currently the busy season (ACT 21). If it is determined that it is currently the busy season (YES in ACT 21), the cart determining unit 302 determines the cart K positioned at the position closest to the product-to-pick, based on the position information on the position where the product is stored and the position information of the cart K (that is, the cart terminal 1) (ACT 22). The control unit 300 stores the determined cart number of the cart K in the cart number unit 3315 and the cart number unit 3441. Next, the control unit 300 determines the movement route of the cart K based on the order information stored in the order product unit 331 and the position information of the cart K (ACT 23).

Next, the control unit 300 determines a worker to perform the picking operation (ACT 24). Regarding determining a worker in ACT 23, as a first option, a skilled worker who is involved in picking the products of the shop of the ordered party is determined. In this case, the worker with the highest skill level is determined based on the skill level stored in the skill level unit 3433. Further, in this case, since the movement route of the cart K is determined, the worker may not be necessarily the one who is skilled for the shop of the ordered party. For example, as a second option, the worker closest to the product-to-pick may be determined based on the position of the worker stored in the position information unit 3434. It should be noted that when determining the worker, the worker who is already at work is excluded, based on the information stored in the work cart number unit 3432. The control unit 300 stores the worker ID of the determined worker in the worker ID unit 3442. Further, as a third option, for example, a worker who is closest to the product-to-pick among the workers having a skill level of “EXCELLENT” or “GOOD” may be determined.

Next, the control unit 300 transmits instruction information instructing the picking operation to the mobile terminal 7 carried by the determined worker (ACT 25). Then, the product information transmitting unit 303 transmits the order information stored in the order product unit 331 and the route information determined in ACT 23 to the cart terminal 1 attached to the determined cart K (ACT 26). Then, the control unit 300 returns to ACT 11. When receiving the instruction, the worker performs the picking operation for the ordered product using the determined cart K.

Meanwhile, in ACT 21, if the busy season determining unit 301 determines that it is currently not the busy season (that is, it is the low season) (NO in ACT 21), the worker determining unit 304 determines the worker in descending order of skill level concerning the ordering party, based on the information of the ordering party that placed the order (ACT 31). When not in the busy season, workers may not perform picking operations as often as in the busy season. Therefore, it is possible that the picking operation is performed with fewer mistakes, if a skilled worker is determined as the worker even if he or she is at a position farther away, rather than a worker who is positioned closer to the ordered product. As a result, the picking operation time can be shortened. Then, the instruction information transmitting unit 305 transmits the instruction information instructing the picking operation to the mobile terminal 7 carried by the determined worker (ACT 32).

When receiving the instruction information through the mobile terminal 7, the worker determines one cart K placed in the cart storage KO, and transmits the cart number of the corresponding cart K and his/her own worker ID to the server 3 from the cart terminal 1 attached to the determined cart K.

Next, the control unit 300 determines whether or not the cart number and the worker ID are received from the cart K (ACT 33). After the waiting for the reception (NO in ACT 33), if it is determined that the cart number and the worker ID are received (YES in ACT 33), the control unit 300 stores the received cart number in the cart number unit 3441, and stores the received worker ID in the worker ID unit 3442 in association with the cart number unit 3441 that stores the cart number (ACT 34).

Next, the control unit 300 transmits the order information stored in the order product unit 331 to the cart terminal 1 where the cart number is received (ACT 35). In an embodiment, the control unit 300 does not transmit the route information in ACT 35. However, if the skill level of the worker determined in ACT 31 is not high (e.g., if the skill level is “GOOD” or “ACCEPTABLE”), or if the skill level of the worker is low (e.g., if the skill level is “ACCEPTABLE”), the control unit 300 may determine the movement route of the cart K as in the process of ACT 23, and in the process of ACT 35, the control unit 300 may transmit the route information determined as in the process of ACT 26 to the cart terminal 1. Then, the control unit 300 returns to ACT 11.

Further, in ACT 11, if it is determined that an order for product is not received from the shop (NO in ACT 11), the control unit 300 determines whether or not a signal indicating the end of picking is received from the cart terminal 1 (ACT 41). If it is determined that the signal indicating the end of picking is received from the cart terminal 1 (YES in ACT 41), the control unit 300 ends the process. If it is determined that the signal indicating the end of picking is not received from the cart terminal 1 (NO in ACT 41), the control unit 300 determines whether or not the position information is received from the cart terminal 1 or the mobile terminal 7 (ACT 42). If it is determined that the cart number and the position information of the cart K are received from the cart terminal (YES in ACT 42), the control unit 300 stores the latest position information of the cart K in the position information unit 3443 in association with the received cart number (ACT 43). Further, if it is determined that the worker ID and the position information of the worker (that is, the mobile terminal 7) are received from the mobile terminal 7 (YES in ACT 42), the control unit 300 stores the latest position information of the corresponding worker in association with the received worker ID in the position information unit 3434 (ACT 43). If it is determined that the position information is not received from the cart terminal 1 or the mobile terminal 7 (NO in ACT 42), the control unit 300 returns to ACT 11.

As described above, according to the server 3 according to an embodiment, the cart K positioned at a position closest to the product-to-pick is determined, and the order information is transmitted to the cart terminal 1 attached to the cart K. Therefore, the picking operation can be performed with the cart K positioned at the position closest to the product-to-pick such that the time required for the picking operation can be shortened.

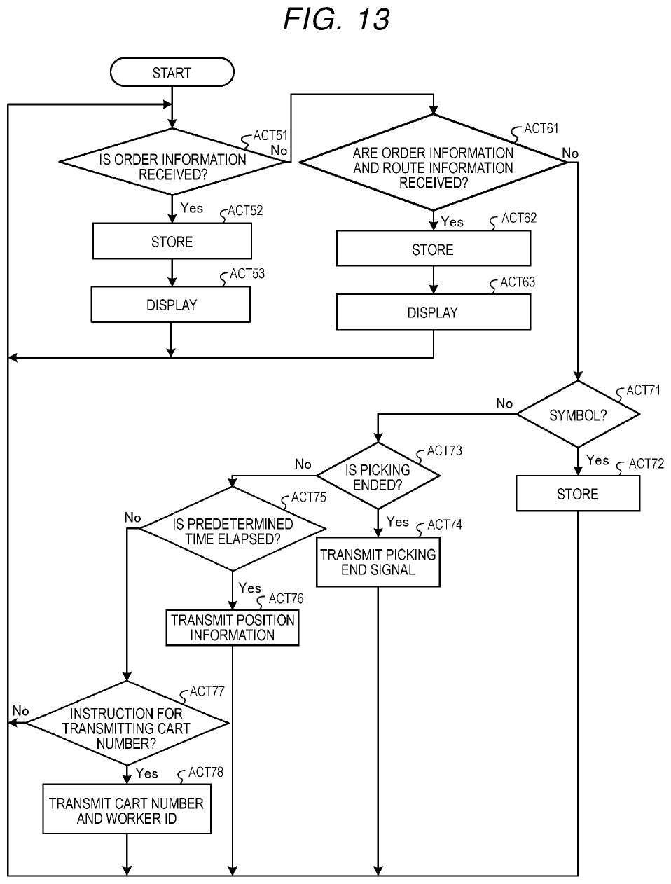

The control of the cart terminal 1 will now be described. FIG. 13 is a flowchart illustrating a flow of control process of the cart terminal 1. As illustrated in FIG. 13, the control unit 100 of the cart terminal 1 determines whether or not the order information is received from the server 3 (ACT 51). If it is determined that the order information is received from the server 3 by the process of ACT 35 (YES in ACT 51), the control unit 100 stores the order information in the order product unit 131 (ACT 52). Then, the control unit 100 displays the order information stored in the order product unit 131 on the display unit 18 (ACT 53). Then, the control unit 100 returns to ACT 51.

If it is determined that the order information is not received from the server 3 (NO in ACT 51), the control unit 100 determines whether or not the order information and the route information are received from the server 3 (ACT 61). If it is determined that the order information and the route information are received from the server 3 by the process of ACT 26 (YES in ACT 61), the control unit 100 stores the order information in the order product unit 131 (ACT 62). Further, the control unit 100 stores the received route information in the route storage unit 132 (ACT 62). Then, the control unit 100 displays the product information stored in the order product unit 131 on the display unit 18 (ACT 63). Further, the control unit 100 displays the route information stored in the route storage unit 132 on the display unit 18 (ACT 63). Then, the control unit 100 returns to ACT 51.

If it is determined that the order information and the route information are not received from the server 3 (NO in ACT 61), the control unit 100 determines whether or not the symbol attached to the product is read by the scanner 21 (ACT 71). If it is determined that the symbol attached to the product is read (YES in ACT 71), the control unit 100 reads the product information of the corresponding product stored in the product master 142 based on the read symbol and stores the read information in the product information unit 133 (ACT 72). Then, the control unit 100 returns to ACT 51.

If it is determined that the symbol attached to the product is not read (NO in ACT 71), the control unit 100 determines whether or not it is operated to end picking (ACT 73). If it is determined that it is operated to end picking (YES in ACT 73), the control unit 100 transmits a signal indicating the end of picking to the server 3 (ACT 74). Then, the control unit 100 returns to ACT 51. If all the ordered products are stored in the product information unit 133, it can be operated to end picking. If all the ordered products are not stored in the product information unit 133, it cannot be operated to end picking.

If it is determined that it is not operated to end picking (NO in ACT 73), the control unit 100 determines whether or not a predetermined time (e.g., 1 minute) elapses (ACT 75). If it is determined that the predetermined time elapses (YES in ACT 75), the control unit 100 transmits the position information of the current cart terminal 1 (that is, the cart K) to the server 3 (ACT 76). Then, the control unit 100 returns to ACT 51.

If it is determined that the predetermined time is not elapsed (NO in ACT 75), the control unit 100 determines whether or not the transmission of the cart number is instructed (ACT 77). In ACT 32, if the worker receives the picking instruction through the mobile terminal 7, the worker determines the cart K to be used at the discretion of the worker. Then, the worker operates the operation unit 17 to transmit the cart number of the determined cart K (e.g., stored in the cart terminal 1) and his/her own worker ID (e.g., inputted by reading the nameplate with the ID reader 20) to the server 3 in associated with each other. The control unit 100 determines whether or not the transmission operation is performed (ACT 77). If it is determined that the transmission operation is performed (YES in ACT 77), the control unit 100 transmits the corresponding cart number and the worker ID to the server 3 (ACT 78). Then, the control unit 100 returns to ACT 51. Further, if it is determined that the transmission operation is not performed (NO in ACT 77), the control unit 100 returns to ACT 51.

As described above, the server 3 according to an embodiment includes the area information unit 342 configured to store the storage position of the product in association with each product, the cart information unit 344 configured to store the position of the cart K, the cart determining unit 302 configured to determine the cart K positioned closest to the product-to-pick which is ordered from the ordering party, based on the storage position of the product and the position of the cart K, and the product information transmitting unit 303 determined to transmit the order information on the product-to-pick to the cart terminal 1 attached to the determined cart K for display thereof.

As described above, the server 3 according to an embodiment determines the cart K positioned at the position closest to the product-to-pick and transmits the order information thereto, so that the movement distance of the cart K for picking operation is short, and accordingly, it is possible to shorten the time required for the picking operation.

Further, the server 3 according to an embodiment includes the worker information unit 343 configured to store, for each worker, the skill level for picking the products of the ordering party for each ordering party, the worker determining unit 304 configured to determine a worker in descending order of skill level concerning the ordering party, based on the information on the ordering party that placed the order, and the instruction information transmitting unit 305 configured to transmit the picking instruction information to the mobile terminal 7 carried by the determined worker.

As described above, the server 3 according to an embodiment determines the worker in the descending order of skill level concerning the ordering party. Therefore, since the picking operation is performed by the skilled worker, the time required for the picking operation can be shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in an embodiment, the cart determining unit 302 and the product information transmitting unit 303 are operated during the busy season, and the worker determining unit 304 and the instruction information transmitting unit 305 are operated during the non-busy season. However, an exemplary embodiment is not limited thereto, and the cart determining unit 302 and the product information transmitting unit 303, and the worker determining unit 304 and the instruction information transmitting unit 305 may be operated according to a classification other than the classification of the busy season and the non-busy season.

The program executed on the server 3 according to an embodiment is provided as a file in an installable format or an executable format recorded on a computer-readable recording medium such as a CD-ROM, a flexible disk (FD), a CD-R, a Digital Versatile Disk (DVD) and the like.

Further, it may be configured such that the program executed by the server 3 according to an embodiment is stored on a computer connected to a network such as the Internet and the like and provided by being downloaded via the network. Further, it may be configured such that the program executed by the server 3 according to an embodiment is provided or distributed via a network such as the Internet and the like.

Further, it may be configured such that the program executed by the server 3 according to an embodiment is provided by being incorporated into ROM or the like in advance.

What is claimed is:

1. A server, comprising:
a product position storage component configured to store a storage position of a product in association with each product;
a cart position storage component configured to store a position of a cart;
a cart determining component configured to determine a cart positioned closest to a product-to-pick ordered from an ordering party, based on the storage position of the product and the position of the cart; and
a product information transmitting component configured to transmit information on the product-to-pick to a cart terminal attached to the determined cart for display thereof.

2. The server according to claim 1, further comprising:
a busy season determining component configured to determine whether or not a busy season exists,
wherein the cart determining component determines the cart positioned closest to the product-to-pick if the busy season exists.

3. The server according to claim 1, wherein the cart determining component determines the cart positioned closest to a product-to-pick based upon a coordinate system within a warehouse.

4. The server according to claim 1, wherein the product information transmitting component transmits information wirelessly.

5. The server according to claim 1, wherein the product information transmitting component transmits product code information.

6. The server according to claim 1, wherein the product information transmitting component transmits information to the determined cart selected from among a plurality of carts.

7. A server, comprising:
a skill level storage component configured to store, for each worker, a skill level for picking a product of an ordering party for each ordering party;
a worker determining component configured to determine a worker in a descending order of skill level concerning the ordering party based on information on the ordering party that placed an order; and
an instruction information transmitting component configured to transmit picking instruction information to a mobile terminal carried by the determined worker.

8. The server according to claim 7, further comprising:
a busy season determining component configured to determine whether or not a busy season exists,
wherein the worker determining component determines the worker based on the skill level if the busy season does not exist.

9. The server according to claim 7, wherein the worker determining component is further configured to determines the worker based upon a coordinate system within a warehouse.

10. The server according to claim 7, wherein the instruction information transmitting component transmits picking instruction information wirelessly.

11. The server according to claim 7, wherein the instruction information transmitting component further transmits product code information.

12. The server according to claim 7, wherein the instruction information transmitting component transmits picking instruction information to the determined worker selected from among a plurality of workers.

13. A method using a server including a product position storage component configured to store a storage position of a product in association with each product, and a cart position storage component configured to store a position of a cart, the method comprising:
determining a cart positioned closest to a product-to-pick ordered from an ordering party, based on the storage position of the product and the position of the cart; and
transmitting information on the product-to-pick to a cart terminal attached to the determined cart for display thereof.

14. The method according to claim 13, further comprising:
determining whether or not a busy season exists; and
determining the cart positioned closest to the product-to-pick if the busy season exists.

15. The method according to claim 13, further comprising:
determining the cart positioned closest to a product-to-pick based upon a coordinate system within a warehouse.

16. The method according to claim 13, further comprising:
transmitting product code information.

17. A method using a server including a skill level storage component configured to store, for each worker, a skill level for picking a product of an ordering party for each ordering party, the method comprising:
determining a worker in a descending order of skill level concerning the ordering party based on information on the ordering party that placed an order; and
transmitting picking instruction information to a mobile terminal carried by the determined worker.

18. The method according to claim 17, further comprising:
determining the worker based upon a coordinate system within a warehouse.

19. The method according to claim 17, further comprising:
transmitting product code information.

20. The method according to claim 17, further comprising:
transmitting picking instruction information to the determined worker selected from among a plurality of workers.
